(19) United States
(12) Patent Application Publication
(10) Pub. No.: US 2010/0114701 A1
(43) Pub. Date: May 6, 2010

(54) SYSTEM AND METHOD FOR BRAND AFFINITY CONTENT DISTRIBUTION AND OPTIMIZATION WITH CHARITABLE ORGANIZATIONS

(75) Inventors: Ryan Steelberg, Irvine, CA (US); Chad Steelberg, Newport Beach, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Brand Affinity Technologies, Inc., Irvine, CA (US)

(21) Appl. No.: 12/478,021

(22) Filed: Jun. 4, 2009

Related U.S. Application Data
(63) Continuation-in-part of application No. 12/144,194, filed on Jun. 23, 2008.
Application No. 12/144,194 is a continuation-in-part of application No. 12/042,913, filed on Mar. 5, 2008.
Application No. 12/144,194 is a continuation-in-part of application No. 11/981,646, filed on Oct. 31, 2007.
Application No. 11/981,646 is a continuation-in-part of application No. 11/981,837, filed on Oct. 31, 2007.
Application No. 11/981,837 is a continuation-in-part of application No. 12/072,692, filed on Feb. 27, 2008.
Application No. 12/072,692 is a continuation-in-part of application No. 12/079,769, filed on Mar. 27, 2008.
Application No. 12/079,769 is a continuation-in-part of application No. 12/042,913, filed on Mar. 5, 2008.
Application No. 12/042,913 is a continuation-in-part of application No. 12/072,692, filed on Feb. 27, 2008.
Application No. 12/072,692 is a continuation-in-part of application No. 11/981,646, filed on Oct. 31, 2007.
(60) Provisional application No. 61/058,855, filed on Jun. 4, 2008.
(60) Provisional application No. 60/993,096, filed on Sep. 7, 2007.

(51) Int. Cl. G06Q 30/00; G06Q 50/00

(52) U.S. Cl. 705/14.53; 705/14.49; 705/14.54; 705/14.69; 705/14.71; 705/14.72

(57) ABSTRACT

An endorsed advertising engine, system and method, including at least one vault stored in at least one computerized memory location, said at least one vault comprising media assets, wherein at least one of the media assets is directly related to at least one charitable institution, a recommendation engine including at least one database that matches the charitable at least one media asset from the vault with at least one requested creative, and a delivery engine that at least partially electronically prepares for integration and/or integrates the requested creative with the matched, charitable at least one media asset from the vault.

### CROSS-REFERENCE TO RELATED APPLICATIONS

This application claims priority to U.S. Provisional Patent Application Ser. No. 61/058,855, entitled “System and Method for Brand Affinity Content Distribution and Optimization with Charitable Organizations”, filed Jun. 4, 2008, and is a continuation-in-part of: U.S. patent application Ser. No. 12/144,194, entitled “System and Method for Brand Affinity Content Distribution and Optimization”, filed Jun. 23, 2008; and U.S. patent application Ser. No. 12/042,913 entitled “Engine, System and Method for Generation of Brand Affinity Content”, filed Mar. 5, 2008, which applications are hereby incorporated by reference herein as if set forth in their entirety.

U.S. patent application Ser. No. 12/144,194 is: a continuation-in-part of U.S. patent application Ser. No. 11/981,646, entitled “Engine, System and Method for Generation of Brand Affinity Content”, filed Oct. 31, 2007; a continuation-in-part of U.S. patent application Ser. No. 11/981,837, entitled “An Advertising Request And Rules-Based Content Provision Engine, System and Method”, filed Oct. 31, 2007; a continuation-in-part of U.S. patent application Ser. No. 12/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand Affinity Content,” filed Mar. 27, 2008, the disclosures of which are incorporated by reference herein as if set forth in their entirety.

U.S. patent application Ser. No. 11/981,837 claims priority to U.S. Provisional Application Ser. No. 60/993,096, entitled “System and Method for Rule-Based Generation of Brand Affinity Content,” filed Sep. 7, 2007, and is related to U.S. patent application Ser. No. 11/981,646, the disclosures of which are incorporated by reference herein as if set forth in their entirety.

U.S. patent application Ser. No. 12/079,769 is a continuation-in-part of U.S. patent application Ser. No. 12/042,913, entitled “Engine, System and Method for Generation of Brand Affinity Content,” filed Mar. 5, 2008, which is also a continuation-in-part of U.S. patent application Ser. No. 12/072,692, the disclosures of which are incorporated by reference herein as if set forth in their entirety.

U.S. patent application Ser. No. 12/072,692 is a continuation-in-part of U.S. patent application Ser. No. 11/981,646.

### FIELD OF THE INVENTION

The present invention is directed to an advertising engine and, more particularly, to an engine for generation of brand affinity content, and a method of making and using same.

### BACKGROUND OF THE INVENTION

High impact advertising is that advertising that best grabs the attention of a target consumer. A target consumer is the ideal customer for the particular goods being advertised, from a socio-economic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Factors that will increase the impact of an endorser include the endorser's perceived knowledge of particular goods or in a particular industry, the frame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for the obtaining of an endorsement or sponsorship, in the aforementioned high-impact circumstances, either from a specific individual, a specific entity, an affinity brand, a marketing partner, or a sponsor.

### SUMMARY OF THE INVENTION

The present invention provides an endorsed advertising engine, system and method, including at least one vault stored in at least one computerized memory location, said at least one vault comprising media assets, wherein at least one of the media assets is directly related to at least one charitable institution, a recommendation engine including at least one database that matches the charitable at least one media asset from the vault with at least one requested creative, and a delivery engine that at least partially electronically prepares for integration and/or integrates the requested creative with the matched, charitable at least one media asset from the vault.

Thus, the present invention provides an engine, system and method that allows for the obtaining of an endorsement or sponsorship, in the aforementioned high-impact circumstances, and more particularly employing a charitable supporter, in the form of a specific individual, a specific entity, an affinity brand, a marketing partner, or a sponsor.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an exemplary embodiment of the present invention;

FIG. 2 illustrates an exemplary embodiment of the present invention;

FIG. 3 illustrates an exemplary embodiment of the present invention; and

FIG. 4 illustrates an exemplary embodiment of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in advertising engines, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the frame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

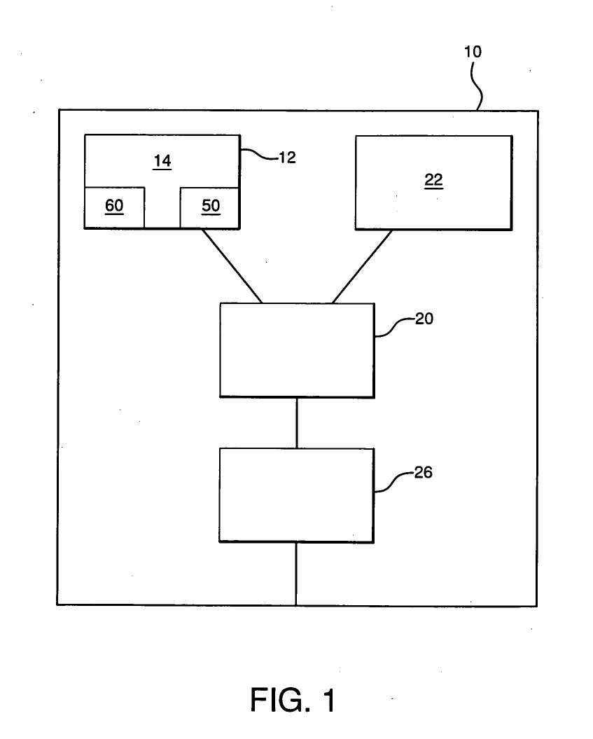

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 1, may include a vault 12 that provides media assets 14 and integration of media assets without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, late stage binding of the ad 22 and media asset 16 upon delivery to strongest target consumers, and delivery of the ad 22 and the dynamic media asset 16 from the vault to an advertiser or advertising server, which then places the mash up of the ad and media asset. Ad requests 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography, demographic and daypart information. Gathered data intelligence may be used as individual properties in conjunction with each other to form or produce the level of intelligence needed to achieve the desired efficiencies. By way of further example, data intelligence may also include information regarding the number of impressions an ad has received, the elapsed time between an impression or a click.

Utilizing the data intelligence will allow the delivery engine 26 to optimize targeting to new and past targets. Optimization may include efficiencies of time and control over redundancies and ad targeting. Optimization will allow for the prediction of probable impressions or clicks that a certain ad or creative may receive when, for example, pointed towards certain factors, such as demographic and geography, for example. A prediction may also be made regarding the efficiency of paid searches and may be further contrasted with, for example, display ads. Such information as drawn from the data intelligence may also allow for the higher success rates related to redundant ad placement based on the prior behavior of a particular audience. The same can be true for the avoidance of redundancy when, for example, data intelligence may be used to keep certain ads or creatives from repeatedly reaching an audience with, for example, low click-through rates. Redundancy avoidance may also include the avoidance of competing ads or creatives, whether or not placed for the same entity.

The delivery engine 26 may also choose to deactivate and/or modify certain creatives based on data intelligence and/or user direction. By way of non-limiting example, the data intelligence may be collected from several ad or creative types over any number of varying media formats, allowing for even more sophisticated optimization based on the allocation of impressions and clicks in the various media formats. Media formats may include, but are not limited to, internet, t.v., radio, mobile devices, kiosks, billboards, product placements, and print. By further way of non-limiting example, data intelligence gathered during a run of a creative on the radio may effect the play of an ad on the internet. The delivery engine 26 may additionally allow for the interplay between data intelligence and real time metrics or community-based information. This real time intelligence gathering may also be used to calibrate a campaign(s) of multiple ads or creatives. By way of non-limiting example only, a campaign of with several creative versions may be measured based on gathered data intelligence and optimized to improve, for example, click-through. Such optimization may be done in real time and over multiple media types. The optimization may, by way of further non-limiting example, call for the addition of ads or creatives not currently apart of the campaign(s). Thus suggesting what type of ads or creatives are required for maximum optimization regardless of whether or not the ads or creatives reside in inventory.

Optimization of ads and creatives increases the value of ad and creative inventory and may, for example, provide for greater value pre and post delivery. The data intelligence may also allow for real-time valuations based on pre-existing and predicted variables, thus maximizing the value of the placed ad or ad/creative inventory. Value can be also maximized for premium and non-premium content. Functionality within the delivery engine 26 may also allow for variable rate sampling and frequency cap forecasting.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

For example, it is known in the existing art to engage in a myriad of different types of advertisement online. Two such advertisement types are: a search advertising model, in which a user undertakes to search for a good or service of interest and receives, as part of or as indicated with a search result(s), advertisements relevant to purchasing the good or service for which the search was made and/or to purchasing goods or services related to the good or service for which the search was made; and a display advertising model, in which a user is actively viewing a web site and receives, as part of the web site under review, advertisements for the purchase of goods or services relevant to the content of the web site under review. Needless to say, the former operates on the principal that, if a user searches for a good or service, he/she would like to buy that good or service, and the latter operates on the principal that if a user is interested enough in the content of a web site to view that web site, he/she is also likely interested in buying goods or services related to the content of that web site.

The display advertising model mentioned hereinabove is typically embodied as banner on a web site. For example, such banners may appear above, below, to the left, or to the right of the content being viewed, but typically do not impinge upon the content being viewed. The search advertising model mentioned hereinabove is typically embodied as advertisements/banners placed proximate to search results on the search results page responsive to the user search. For example, such advertisements may appear along a right hand side of a search results page, while the search results are displayed along the left hand side of the same search results page.

As discussed immediately above, it is necessarily the case that the correlations performed between the user's searched or viewed content and the advertisements provided will increase the relevance of, and thus the response to, the advertisements. However, such responses in the form of either clicks on the advertisements or purchases made through the advertisement link, once obtained at a particular rate, cannot be further improved by the relevance of the advertisements produced. Rather, the only manner to improve the response rate once relevant advertisements are produced is to improve the advertisements themselves based on the users viewing the advertisements.

The present invention provides such improved response advertisement through the provision of brand affiliations with the goods and services being advertised, as discussed hereinthroughout. As discussed, the present invention allows for the production of advertisements having brand sponsorship that is optimized to the market sought. That is, the brand sponsor selected for an advertised good or service is, though the use of the present invention, selected to best correspond to the characteristics of the purchaser sought by the advertisement.

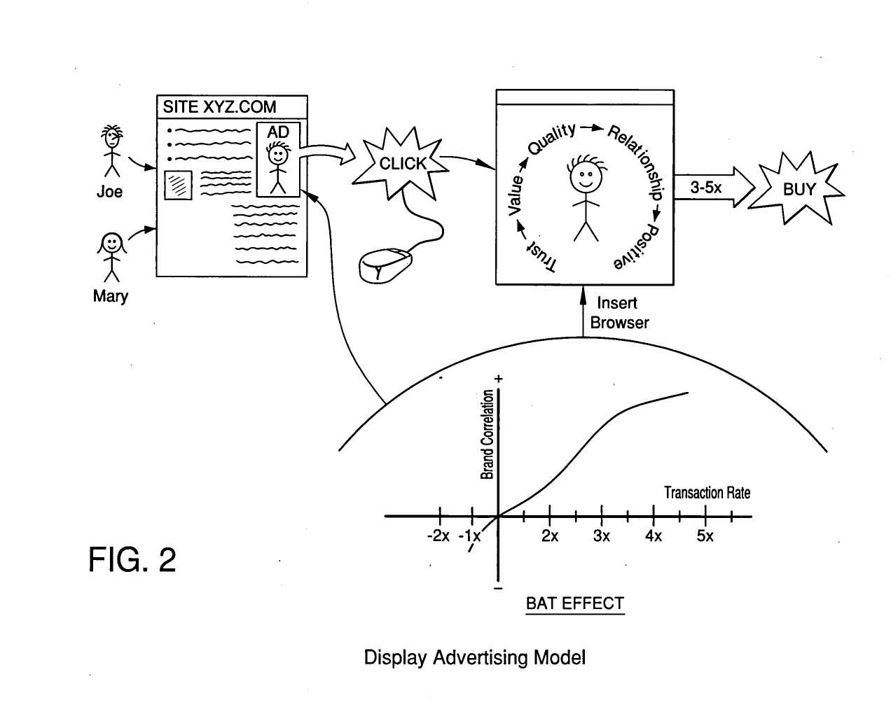

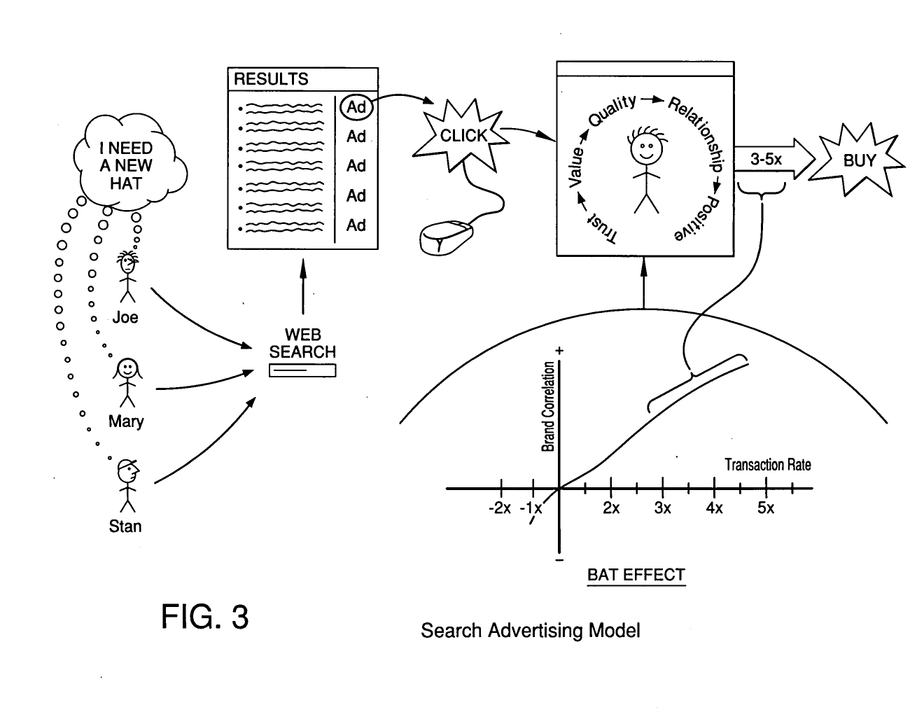

This effect is illustrated with respect to FIGS. 2 and 3. FIG. 2 illustrates the effect of the present invention with regard to a search advertising model, and FIG. 3 illustrates the effect of the present invention with respect to a display advertising model. In each Figure, a brand sponsor has been selected who will indicate, to the user for whom the advertisement is deemed most relevant, trust, quality, value, a relationship to the user, and/or an overall positive feeling. The sponsor is either selected by the advertiser in the present invention for inclusion with the subject advertisement, based on the profile of a desired purchaser and the characteristics of that sponsor as they relate to that profile, which relation is set forth or suggested by the present invention, or the sponsor is selected by the present invention for inclusion in or with the subject advertiser's advertisement based on a desired responder profile for the advertisement entered by the advertiser to the engine of the present invention.

As illustrated graphically in FIGS. 2 and 3, a positive correlation of a brand sponsor to a brand, which is necessarily also a correlation of a brand sponsor to those purchasers most interested in buying the subject brand, correlates positively to a increased transaction rate. In other words, to the extent the present invention provides brand affiliations, sponsorships, and the like that are well-suited to the sponsored brand, that brand will show an increase in the number of users who are shown that advertisement and that either click that advertisement or purchase that brand through that advertisement. It is estimated that the increase in the desired response rate in accordance with the use of the present invention may typically be a 3 to 5 times increase, based on the increased positive correlation between the sponsored brand and the brand sponsor provided by the present invention, although those skilled in the art will understand that more or less improvement in the transaction rate may occur based on the implementation of the present invention.

Thus, in accordance with the present invention, and as illustrated in FIGS. 2 and 3, an increased correlation of a brand sponsor to a sponsoring brand, and thus an increased correlation of a sponsoring brand to a desired purchaser's profile, is provided. This increased correlation generates an improved transaction rate in accordance with the present invention, for at least a search advertising model and a display advertising model.

The present invention may also allow for a brand profile 60 to include preferences regarding certain events and organizations of importance to the brand. Such events may include disaster relief and humanitarian causes while specific organizations may include charities such as the Red Cross or The United Way, for example. The profile may also allow for multiple listing of events and organizations and allow for varying thresholds to be implemented. For example, a list of organizations may be ranked by importance to the brand, whether positive or negative. Said another way, a brand could list the Red Cross over The United Way based on the fact that the brand favors the Red Cross or that the Red Cross is an organization that the brand does not want to associate. Metrics or similarly gathered information may also be used for the purpose providing or limiting brand association. For example, negative press regarding the public standing of the Red Cross may effect the rating within the profile of a particular brand. Thus, an accounting scandal may cause the disassociation between the brand and the organization.

The same may also be true for endorsers of the brand themselves. For example, a personality in the world of sports may choose to rank highly organizations linked to their home country. Thus, allowing further correlation between brands, ads, talent and organizations and causes. Such correlative information may allow a user of the system to choose to use content which favors certain specific organizations or causes. Further, such correlation may allow for the brands or endorsers to actively contribute to such organizations or causes when particular creatives are used. For example, the use of a specific creative by a brand may provide a percentage donation to a specific organization. By way of further example, a shoe company may choose to use a creative containing an endorser in the pro-baseball field and the trademarks associated with the Red Cross. The pro-baseball player may have specified that if such creative is used, a specific percentage will be donated to the Red Cross. The specific percentage may be set and changed at any time by the brand or endorser. In accordance with the present invention, the brand or endorser profile may include exclusions such as specific run times, particular markets and DMAs, other brands or endorsers, and/or other organizations and events.

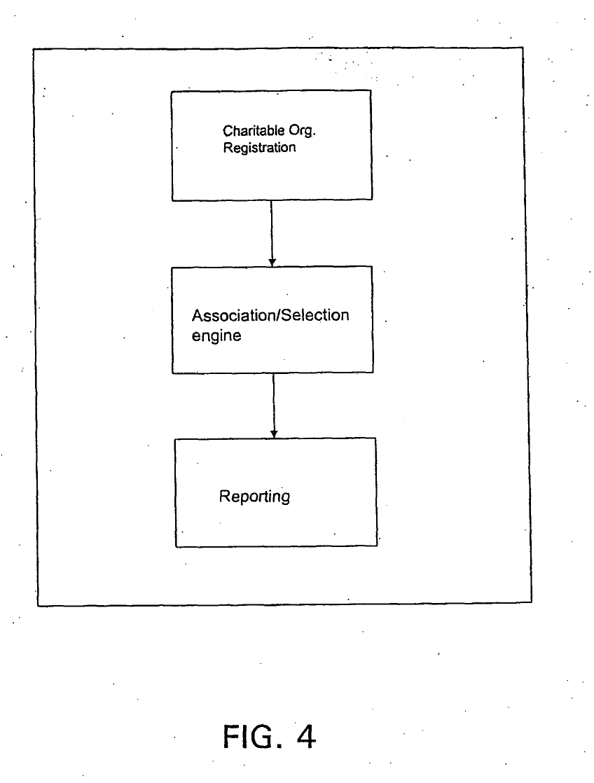

In an aspect of the present invention, as shown in FIG. 4, an organization or event which desires to be associated with a brand or endorser may register with the system. Although an organization or event with generally be open to all brands and/or endorsers, exclusions/preferences may be made. Similarly, once registered, a brand or endorser may select certain organizations or events which to be associated. As described above and shown the FIG. 4, a search feature with filters may facilitate the matching of brands/endorsers to organizations/events.

Once a charity laden ad is used and money from that use is generated in accordance with the present invention, the system will provide the appropriate proceeds to the organization or event and provide to the brand/endorser the appropriate tax forms or tax receipts, if applicable. This will allow for the proper tax eligible deduction to be taken by the brand or endorser and will also provide reporting to the organization or event for similar use. Such information may be archived, stored in the profile 60, and/or transmitted to the Internal Revenue Service, for example. The present invention may also allow creatives/ads to be delivered and run showing only the organization or event. For example, if a particular advertiser seeks to run an ad spotlighting only the Red Cross, the 100% of the monies derived may be tax deductible.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. An endorsed advertising engine, comprising:
at least one vault stored in at least one computerized memory location, said at least one vault comprising media assets, wherein at least one of said media assets is directly related to at least one charitable purpose;
a recommendation engine comprising at least one database that matches the charitably purposed at least one media asset from the vault with at least one requested creative; and
a delivery engine that at least partially electronically prepares the requested creative for integration with the matched, charitably purposed at least one media asset from said vault.

2. The endorsed advertising engine of claim 1, wherein the integration by the delivery engine comprises a late stage binding.

3. The endorsed advertising engine of claim 1, wherein the integration by the delivery engine comprises a separate delivery of the requested creative and the matched, charitably purposed media assets for mash Lip by a third party advertising server.

4. The endorsed advertising engine of claim 1, further comprising an advertising wizard for creation of the requested creative.

5. The endorsed advertising engine of claim 4, wherein the advertising wizard comprises a plurality of blank advertising templates.

6. The endorsed advertising engine of claim 1, wherein the media assets comprise brands other than a brand of the requested creative.

7. The endorsed advertising engine of claim 1, wherein the media assets comprise at least two of statistics, video, pictures, sound bites, symbols, emblems, taglines, press releases, publications, avatars, animations, and web links.

8. The endorsed advertising engine of claim 1, wherein the media assets comprise assets capable of being re-purposed.

9. The endorsed advertising engine of claim 1, wherein the media assets associate with exclusions, inclusions, and preferences of at least one subject of the charitably purposed media assets.

10. The endorsed advertising engine of claim 9, wherein the exclusions comprise at least one of geographic limitations, product limitations, preferred partners, preferred product types, time, date, relationship with other assets, relationship with other media types and conflicts with a pre-existing endorsements.

11. The endorsed advertising engine of claim 1, wherein ones of the media assets comprise payment schema.

12. The endorsed advertising engine of claim 11, wherein the payment a schema vary based on at least one of a requester of the requested creative, the requested creative, delivered asset, and a consumer of the requested creative.

13. The endorsed advertising engine of claim 1, wherein the recommendation engine engages in recommending assets based on exclusions of the media assets, and at least one of secondary information external to the vault and variable factoring.

14. The endorsed advertising engine of claim 13, wherein the variable factoring comprises a brand association between the media asset's brand and a brand of the requested creative.

15. The endorsed advertising engine of claim 1, wherein each media asset comprises a profile of that media asset.

16. The endorsed advertising engine of claim 15, wherein each of the profiles comprises at least a psychological profile of typical users of that media asset's brand, target customers of that media asset's brand, and target affiliate profiles.

17. The endorsed advertising engine of claim 16, wherein the target affiliate profile comprises at least two of desired sharing of marketing costs, desired increasing brand recognition in certain geographies, desired increasing brand recognition in certain fields of use, distribution channel access, expedited market entry, and improved brand perception.

18. The endorsed advertising engine of claim 1, wherein at least two of the matches are presented for selection of one of the matches.

19. The endorsed advertising engine of claim 1, wherein at least one bid for the requested creative is variable in accordance with a quality of the match.

20. An endorsed advertising engine, comprising:
at least one vault comprising a plurality of media assets related to at least two charitable institutions;
computing code that, when executed by at least one processor, provides a recommendation engine that matches at least one media asset from the vault with at least one asset backed media; and
computing code that provides a delivery engine that integrates the asset backed media with the matched at least one media asset from the vault.

21. The endorsed advertising engine of claim 20, wherein the integration by the delivery engine comprises a late stage binding.

22. The endorsed advertising engine of claim 20, wherein the integration by the delivery engine comprises a pre-binding.

23. The endorsed advertising engine of claim 20, wherein the integration by the delivery engine comprises keyword request matching.

24. The endorsed advertising engine of claim 20, wherein the integration by the delivery engine comprises delivery based on a query.

25. The endorsed advertising engine of claim 20, wherein the asset backed media is at least a portion of an advertising request.

26. The endorsed advertising engine of claim 20, wherein the integration by the delivery engine comprises dynamic content on a sponsoring page.

27. The endorsed advertising engine of claim 20, wherein the integration by the delivery engine comprises a separate delivery of the asset backed media and the matched media assets for mash up by a third part advertising server.

28. The endorsed advertising engine of claim 20, further comprising an advertising wizard for creation of the asset backed media.

29. The endorsed advertising engine of claim 28, wherein the advertising wizard comprises a plurality of blank advertising templates.

30. The endorsed advertising engine of claim 20, wherein the media assets comprise brands other than a brand of the asset backed media.

31. The endorsed advertising engine of claim 20, wherein the media assets comprise at least two of statistics, video, pictures, sound bites, symbols, emblems, taglines, press releases, publications, avatars, animations and web links.

32. The endorsed advertising engine of claim 20, wherein the media assets comprise assets capable of being re-purposed.

33. The endorsed advertising engine of claim 20, wherein the media assets are associated with exclusions, inclusions, and preferences of a subject of the media assets.

34. The endorsed advertising engine of claim 33, wherein the exclusions comprise at least one of geographic limitations, product limitations, preferred partners, preferred product types, time, date, relationship with other assets, relationship with other media types and conflicts with a pre-existing endorsements.

35. The endorsed advertising engine of claim 20, wherein the media assets associate with payment schema.

36. The endorsed advertising engine of claim 35, wherein the payment schema vary based on at least one of the requester of the asset backed media, the asset backed media, a delivered asset, and a consumer of the asset backed media.

37. The endorsed advertising engine of claim 20, wherein the recommendation engine engages in recommending assets based on exclusions of the media assets, and at least one of secondary information external to the vault and variable factoring.

38. The endorsed advertising engine of claim 37, wherein the variable factoring comprises a brand association between the media asset's brand and a brand of the requested creative.

39. The endorsed advertising engine of claim 20, wherein each media asset comprises a profile of that media asset.

40. The endorsed advertising engine of claim 39, wherein each of the profiles comprises at least a psychological profile of typical users of that media asset's brand, target customers of that media asset's brand, and target affiliate profiles.

41. The endorsed advertising engine of claim 40, wherein the target affiliate profile comprises at least two of desired sharing of marketing costs, desired increasing brand recognition in certain geographies, desired increasing brand recognition in certain fields of use, distribution channel access, expedited market entry, and improved brand perception.

42. The endorsed advertising engine of claim 20, wherein at least two of the matches are presented for selection of one of the matches.

43. The endorsed advertising engine of claim 20, wherein at least one bid for the asset backed media is variable in accordance with a quality of the match.

44. A method of providing an endorsed advertisement, comprising:
relationally storing a plurality of media assets related to at least two charitable institutions;
matching at least one of the relationally stored media assets with at least one asset backed media; and
at least partially integrating the asset backed media with the matched at least one media asset from the vault to form an advertisement, wherein the matched at least one media asset comprises the endorsement of the advertisement.
